(19) United States
(12) Patent Application Publication
(10) Pub. No.: US 2006/0046742 A1
(43) Pub. Date: Mar. 2, 2006

(54) Enabling access to private information

(75) Inventor: Honglei Zhang, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/925,538

(22) Filed: Aug. 25, 2004

(51) Int. Cl. H04Q 7/20

(52) U.S. Cl. 455/456.2

(57) ABSTRACT

A method for enabling access to private information, such as private information, at a first radio telecommunications device comprising: assigning an access level to a first entity; receiving a request for private information from the first entity; determining, using the assigned access level, whether the first entity is entitled to access the requested private information; and if there is entitlement, enabling the first entity to access the private information.

### FIELD OF THE INVENTION

Embodiments of the present invention relate to a method of enabling access to private information such as location information. In particular they relate to a method, a computer program and devices for enabling access to private information for use in hand portable radio telecommunications devices.

### BACKGROUND TO THE INVENTION

In some location based services used in current radio telecommunications devices it is useful for information about the location of a radio telecommunications device to be available to other devices. Current methods of making this information available involve a first device sending a request for location information to a second device. The user of the second device may be able to arrange the device so that the device may automatically either accept all requests or reject all requests without user input.

### BRIEF DESCRIPTION OF THE INVENTION

According to one embodiment of the present invention there is provided a method for enabling access to private information at a first radio telecommunications device comprising: assigning an access level to a first entity; receiving a request for private information from the first entity; determining, using the assigned access level, whether the first entity is entitled to access the requested private information; and if there is entitlement, enabling the first entity to access the private information.

The private information may identify the location of the first radio telecommunications device.

The access level may, for example, be assigned by including the first entity in an ‘authorised list’ that identifies the entities that are entitled to access.

The access level may, for example, be assigned by including the first entity in an ‘unauthorised list’ that identifies the entities that are not entitled to access.

The access level may, for example, include conditions for access. A condition may be positive, in the sense that it must be satisfied if access is to be allowed, or it may be negative in the sense that if it is satisfied access will not be allowed. The conditions may, for example, relate to the time of day, the mode of the first device, the location of the first device etc.

A user may be able to assign an access level to an entity. The user may, for example, select a predetermined access level for an entity or, for example, define an access level for an entity by specifying the condition(s) of access.

According to another embodiment of the present invention there is provided a radio telecommunications device comprising; a transmitter for transmitting private information; a receiver for receiving requests for private information; a memory for storing an indication of an access level assigned to a first entity; a processor for determining, after a request for private information has been received from a first entity, using the stored indication, whether the first entity is entitled to the requested private information and, if there is entitlement, enabling the first entity access to the private information.

According to another embodiment of the present invention there is provided a radio telecommunications device comprising; a user interface for enabling a user of the device to assign different access rights to private information to different entities, wherein the device responds to requests for private information from an entity in dependence upon the access right previously assigned to the entity.

According to another embodiment of the present invention there is provided a computer program comprising program instructions for enabling access to private information and comprising; means for enabling a user of a first device to assign to a first entity an access level, and means for determining, after a request for private information has been received from the first entity, using the assigned access level, whether the first entity is entitled to the requested private information and, if there is entitlement, enabling the first entity access to the private information.

According to another embodiment of the present invention there is provided a method for enabling access to a plurality of different types of private information at a first radio telecommunications device comprising: enabling a user of the first device to assign an access level to a first entity wherein the access level defines which of the plurality of different types of private information the first entity is entitled to access; receiving a request for a first type of private information from the first entity; determining, using the assigned access level, whether the first entity is entitled to access the requested first type of private information; and if there is entitlement, enabling the first entity to access the requested first type of private information.

This embodiment of the present invention can be used for many different types of private information. Private information may include, among other things, contemporaneous information relating to the current environment of the second device (e.g. location or weather), user input information (e.g. diary entries or a task list) or received information. The user of the first device can authorise access to many different types of information at once.

The access level assigned may be one of a plurality of defined access levels and each level defines a different combination of types of private information. This allows the user of the first device to choose which combination of private information the first entity is entitled to access. For instance, the user may wish to enable their best friend to access more private information than their other friends. The user may assign their best friend to an access level which enables them to access a first and a second type of private information but the other friends may be assigned to an access level which only entitles them to access the first type of information.

When the first device receives a request for a first type of private information from the first entity, the first device may automatically determine whether the first entity is entitled to access the requested first type of private information. This embodiment provides the advantage that once the access level has been assigned the user of the first device does not have to manually answer requests for information. This is particularly useful if, for instance, the user is receiving a large number of requests and does not want to be repeatedly have to answer them. Also if the user is busy and cannot personally answer the requests the device will answer them automatically.

The user of the first device may assign an access level to the first entity in response to an initial request for a type of private information by the first entity.

After the user of the first device has assigned an access level to the first entity, the first device may send an authentication code to the first entity that entitles the first entity access to the combination of types of private information defined by the access level. The authentication code provides an indication of the assigned access level. The authentication code can be included in requests for private information from the first entity so that the first device can use the code to determine whether the first entity is entitled to the requested information. The same authentication code may be assigned to multiple entities. An entity is a device or a person. If an authentication code is assigned to a person the person may be able to access the private information from different devices, for example, from their mobile telephone or a computer.

Preferably the user of the first device is able to control the access levels and authentication codes so that they can change the type of private information which the first entity is entitled to access. This allows the user of the first device to change their mind about the combination of information which the first entity is entitled to access. This may also be useful if the user makes a mistake when assigning an access code.

An assigned access level may define at least one condition that must be satisfied if the first entity is to be entitled to access the private information or, alternatively, which if satisfied prevents the first entity being entitled to access the private information. For example, the user may specify that an access level entitles the first entity to access a type of private information only at certain times of the day and/or only when the first device is not in a certain location and/or only if the first device is in a particular mode.

According to another embodiment of the present invention there is provided a radio telecommunications device comprising; a transmitter for transmitting a plurality of different types of private information, a receiver for receiving requests for a plurality of different types of private information, a user interface for enabling a user of the device to assign an access level to a first entity wherein the access level defines which of the plurality of different types of private information the first entity is entitled to access, a processor for determining, after a request for a first type of private information has been received from a first entity, whether the first entity is entitled to the requested first type of private information and, if there is entitlement, enabling the first entity access to the first type of private information.

The user interface may enables the user to assign an access level for private information, from a plurality of defined access levels. Each access level may define a different type of private information.

The user interface may enable the user to change the access level assigned to the first entity. The user interface may enable the user to control what combinations of types of private information are accessible with the access levels.

The processor may automatically determine whether the first entity is entitled to access the requested first type of private information. The processor may be arranged to allocate an authentication code to the first entity depending on the access level that the first entity has been assigned. The transmitter may be arranged to transmit the authentication code.

The receiver may be arranged to receive requests for private information comprising an identification of the type of private information requested and an authentication code. The processor may be arranged to determine if the authentication code used in the request for a first type private information from the first entity entitles the first entity to the first type of private information.

The transmitter of the first device may also transmit requests for types of private information and the receiver would receiving the requested private information from the another device.. The receiver may receive authentication codes allocated by other devices and the processor may manage the authentication codes so that the requests for private information sent to another device are sent with the authentication code allocated by the another device. This provides the advantage that the first device can receive private information.

According to another embodiment of the present invention there is provided a radio telecommunications device comprising; a user interface for enabling a user of the device to assign an access level for a plurality of different types of private information to a first entity wherein the access level defines which of the plurality of different types of private information the first entity is entitled to access and the device responds to requests for private information from the first entity in dependence upon the assigned access level.

According to a another embodiment of the present invention there is provided a computer program comprising program instructions for enabling access to a plurality of different types of private information and comprising; means for enabling a user of a first device to assign to a first entity an access level wherein the access level defines which of a plurality of different types of private information the first entity is entitled to access, and means for determining, after a request for a first type of private information has been received from a first entity, whether the first entity is entitled to the requested first type of private information and, if there is entitlement, enabling the first entity access to the first type of private information. The computer program may be embodied on a physical entity such as a data carrier or carried on an electromagnetic carrier signal.

According to a further embodiment of the present invention there is provided a method for transmitting private information from a first radio telecommunications device to a second radio telecommunications device comprising: receiving, at the second device, an authentication code from the first device, sending a request for private information to the first device, comprising the authentication code.

The private information may be information that identifies the location of the first radio telecommunications device.

There may be a plurality of different types of private information. In this case, the authentication code may be dependent upon the type of private information to which the second device is entitled. The request for private information to the first device may comprise an identification of a type of private information and the authentication code.

According to yet another aspect of the present invention there is provided a radio telecommunications device comprising: a transmitter for transmitting requests for private information where the request comprises an authentication code, a receiver for receiving private information, and a processor for managing authentication codes so that a request for private information to another device is sent with the authentication code allocated by the another device.

There may be a plurality of different types of private information. In this case, the request comprises an identification of the type private information and the receiver is for receiving a plurality of different types of private information.

### BRIEF DESCRIPTION OF THE DRAWINGS

For a better understanding of the present invention reference will now be made by way of example only to the accompanying drawings in which:

FIG. 1 illustrates a local area network;

FIG. 2 illustrates a wide area network;

FIG. 3 illustrates a schematic diagram of a device;

FIGS. 4A and 4B illustrates a method of enabling access to a first type of private information at a first device; and

FIG. 5 illustrates a method of a second device requesting access to a first type of private information from a first device.

### DETAILED DESCRIPTION OF EMBODIMENTS OF THE INVENTION

The figures illustrate a method for enabling access to private information 66, such as private information, at a first radio telecommunications device comprising: enabling a user of the first device to assign 42 an access level to a first entity; receiving a request 66 for private information 66 from the first entity; determining 48, using the assigned access level, whether the first entity is entitled to access the requested private information 66; and if there is entitlement, enabling the first entity to access the requested private information 66.

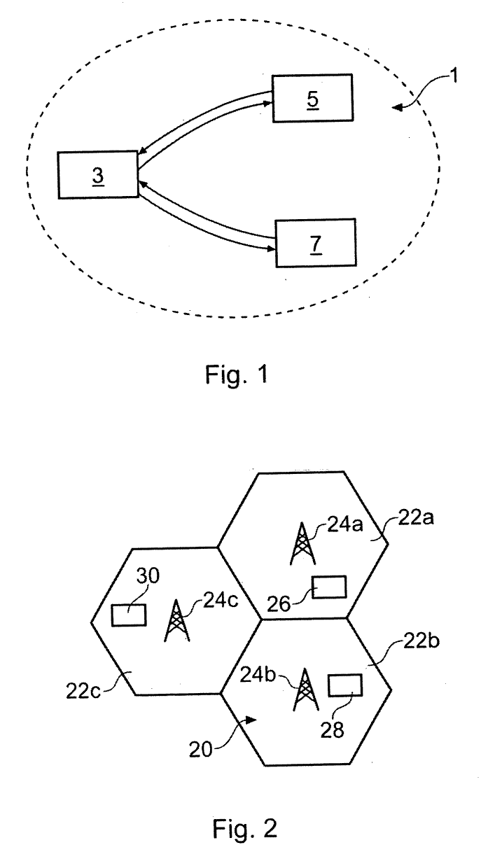

In the embodiments described in the following description the first entity is a second device, however the first entity could also be a person. The first and second devices may be radio telecommunications devices suitable for operating in either or both of networks 1 and 20 illustrated in FIGS. 1 and 2. Any of the devices 3, 5, 7, 26, 28 and 30, illustrated in these networks could be either the first device or the second device however for succinctness in the following description the first device is simply referred to as device 3 and the second device as device 5.

FIG. 1 illustrates a local area network 1 comprising, in this example, three radio telecommunications devices 3, 5 and 7. The radio telecommunications devices 3, 5 and 7 may be hand portable devices, for instance, mobile cellular telephones or personal digital assistants. The network 1 has no formal structure and the device 3 can send messages directly to and receive messages directly from devices 5 and 7 without any intermediary structure. The network 1 may be a wireless LAN or a BLUETOOTH network which is an example of an ad hoc low power radio frequency network.

FIG. 2 illustrates a mobile telephone network 20. The network 20 shown is a cellular radio telecommunications network comprising a number of cells 22, only three of these cells 22a, b and c are illustrated in FIG. 2. A base station 24 is located within each cell 22. The base stations 24a, b and c are connected via the mobile telecommunications network. Three radio telecommunications devices 26, 28 and 30 are shown in FIG. 2, these devices may be mobile cellular telephones and may be able to move freely between cells 22. To communicate in the cellular network 20 the devices 26, 28 and 30 send and receive messages via the base stations 24a, b and c. For example, when the device 26 sends a message to the device 28 the message is first received at the base station 24a then sent via the mobile telecommunications network to base station 24b where it is sent on to device 28.

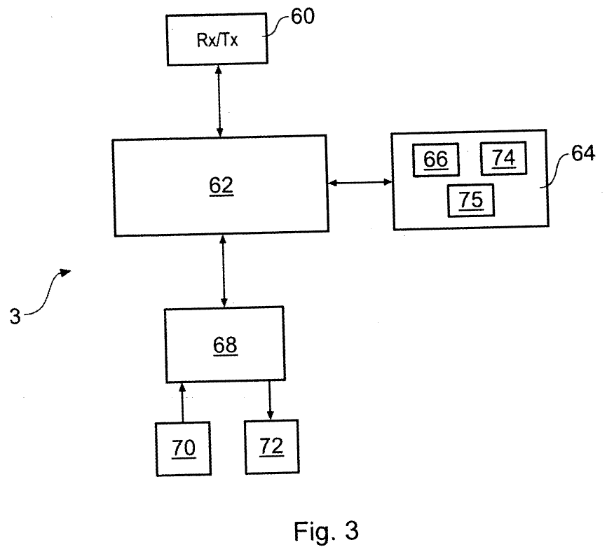

FIG. 3 illustrates a schematic diagram of a first device 3. The first device 3 comprises a radio transceiver 60, a processor 62, a memory 64 for storing private information 66 and authentication codes 74 and a user interface 68 comprising input means 70 and a display 72.

The private information 66 comprises a plurality of different types of information. These different types of information may include information relating to the environment in which the first device is situated, such as, current temperature, weather or location. The private information 66 may also include user input information, for example, diary entries or a task list.

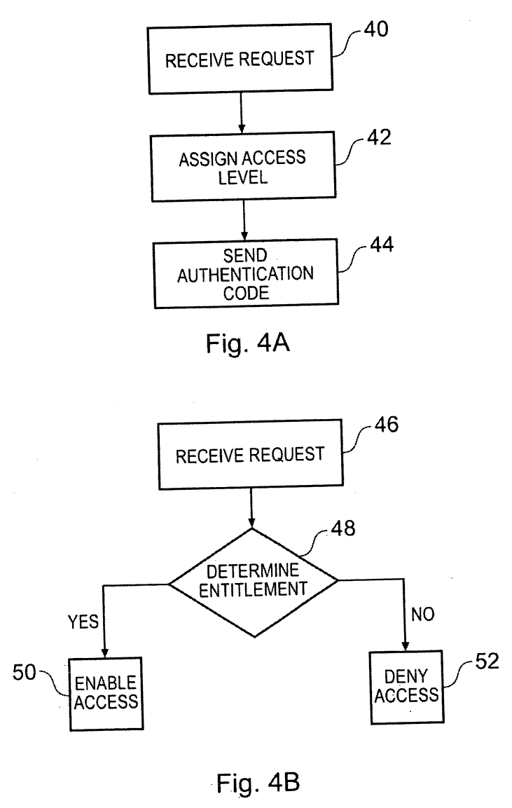

FIGS. 4A and 4B illustrates a series of method steps for enabling a second device 5 access to a first type of private information 66 stored in the memory 64 of a first device 3.

Steps 40 to 44 in FIG. 4A illustrate how an access level and authentication code may be assigned by the first device 3 to the second device 5. The access level defines the combination of different types of private information 66 that the second device 5 is entitled to access and the authentication code provides an indication of that level.

At step 40 the first device 3 receives a request for private information 66 from a second device 5. The request may be in any suitable form, for example, an SMS message or an email message. At step 42 the user of the first device 3 assigns an access level to the second -device 5. Once an access level has been assigned an authentication code, indicative of that access level, is allocated and sent 44 to the second device 5. The authentication code may be sent with the requested information.

There are several possible ways in which the access level may be assigned. In one embodiment when the first device 3 receives 40 a request for private information from the second device 5, the user is given an opportunity to use the user interface 68 to accept or decline the request. By accepting the request the user can automatically assign an access level to the second device 5. This access level is one that enables access to at least the type of private information requested. In an alternative embodiment the user uses the user interface 68 to assign an access level to second devices stored in a contact list, without having to receive a request first. For example when entering a telephone number into the contact list the user may also be able to assign an access level.

There may be a number of different access levels each one defining a different combination of the different types of private information 66 that the second device 5 is entitled to access. The access levels may also impose a time restriction on the access to private information 66. For instance the second device 5 may be entitled to access the private information 66 only at certain times of the day or only when the first device 3 is in a particular mode of operation, for example, silent mode.

The assignment of an access level only needs to happen once. However the user of the first device 3 may also be able to change the assigned access levels if they wish to change the amount of information a second device is entitled to access.

The authentication code provides an indication of the access level which has been assigned to a second device 5 and may be used by the second device 5 in subsequent requests for private information 66 from the first device 3. The authentication code may be a letter or digit sequence which may be input by the user of the first device 3 or may be generated by a code generator within the first device 3. The same authentication code may be sent to all devices assigned to the same access level or there may be a unique code for each second device 5. Any message which contains an authentication code may be encrypted to prevent the authentication code being obtained by a third party.

Steps 46 to 52 in FIG. 4B illustrate the method steps which occur when the first device 3 receives a request for private information 66 after an access level and an authentication code has been assigned. Steps 46 to 52 may be repeated many times.

At step 46 the first device 3 receives a request for a first type of private information 66 from the second device 5. This request comprises an identification of the requested first type of private information 66 and the authentication code which was sent in step 44.

At step 48 the first device 3 uses the authentication code received to determine whether the second device 5 is entitled to the type of private information 66 requested. The first device 3 checks whether the authentication code received matches any of the codes which have been allocated to second devices 5. If there is a match, the first device 3 then determines which access level is indicated by this authentication code and the combination of the types of private information 66 the access level entitles the second device 5 to access. If the requested type of information 66 is a type of private information 66 which the access level entitles access to, then, at step 50, access to the requested information is enabled for the second device 5. The requested information may be sent to the second device 5 as part of an SMS message or in any other suitable form.

However, if the requested type of information 66 is a type of private information 66 which the access level does not entitle access to, then at step 52, access to the information is not enabled. A message may be sent to the second device 5 to say that access has been denied or the user of the first device may be given the opportunity to accept or reject the request manually.

Steps 46 to 52 may happen automatically without requiring any input from the user of the first device 3. Once the user has assigned an authentication code to the second device 5 the user may not have to manually respond to requests for private information 66 from the second device 5.

The device illustrated in FIG. 3 is suitable for use in the method described above. Radio transceiver 60 is used to receive the requests for private information 66 from second devices 5. The processor 62 uses the authentication codes received with the requests to determine whether or not the second device 5 is entitled to the type of private information requested. If the second device 5 is entitled then the requested private information 66 is retrieved from the memory 64 and sent to the second device 5 by the radio transceiver 60. If the second device 5 is not entitled to the requested information then the information is not sent, the processor 62 may send a message informing the second device 5 that access has been denied or the user may be given an opportunity to accept or reject the request using the user interface 68.

The memory 64 stores computer program instructions 75 that control the operation of the device 3 when loaded into the processor 62. The computer program instructions 75 provide the logic and routines that enables the electronic device to perform the methods illustrated in FIG. 4.

The computer program instructions provide means for enabling a user of a first device to assign to a first entity an access level wherein the access level defines which of a plurality of different types of private information the first entity is entitled to access, and means for determining, after a request for a first type of private information has been received from a first entity, whether the first entity is entitled to the requested first type of private information and, if there is entitlement, enabling the first entity access to the first type of private information.

The computer program instructions may arrive at the device 3 via an electromagnetic carrier signal or be copied from a physical entity such as a computer program product, a memory device or a record medium such as a CD-ROM or DVD. This may occur when the device is being assembled or programmed in the factory.

The first device 3 may also be able to request and receive types of private information from other devices. The radio transceiver 60 may be used to transmit the requests and receive the responses. The memory 64 may be used to store the authentication codes 74 received from the other devices. The processor 62 may be able to manage these codes 74 so that when the first device 3 makes a request to another device, for instance the second device 5, the request is sent with the code allocated by second device 5.

The user interface 68 may enable the user of the first device 3 to organize and control the access levels. For instance the user may be able to change the access level assigned to a second device 5. For example, Janie may be the user of the first device. Janie may use the first device to assign her friends, Katie and Mary and her boyfriend Kevin, to an access level which authorises them to access private information regarding her location and sends them each the same authentication code. Whenever Katie, Mary or Kevin request this information they use the authentication code so that the first device will approve their request automatically and enable access to the information without further input from Janie. If Janie then splits up with her boyfriend Kevin she may no longer want him to be able to find out her location. Janie then uses the user interface 68 to delete the authentication code assigned to Mary, Katie and Kevin and send a new code to Katie and Mary. Now when Kevin tries to request information about her location he no longer has a valid authentication code so the request is not automatically approved.

In another example Janie may originally assign Katie, Mary and Kevin to the same access level but may send them each their own personal authentication codes. When Janie wishes to stop Kevin accessing her location information she can edit her access levels and authentication codes to reassign Kevin's authentication code to a different access level which does not entitle him to her location information.

The user may also be able control the combinations of private information associated with the access levels. The user input device may be used to add or delete types of private information from a combination associated with an access level. For example Janie may have assigned her friends Katie and Mary to an access level which entitles them to access location information and temperature information. She may wish to change their access level so that it entitles them, only to information regarding her location. Rather than assigning a new level and a new authentication code to both Katie and Mary, Janie may be able to delete ‘temperature’ from the combination of information associated with Katie and Mary's access level.

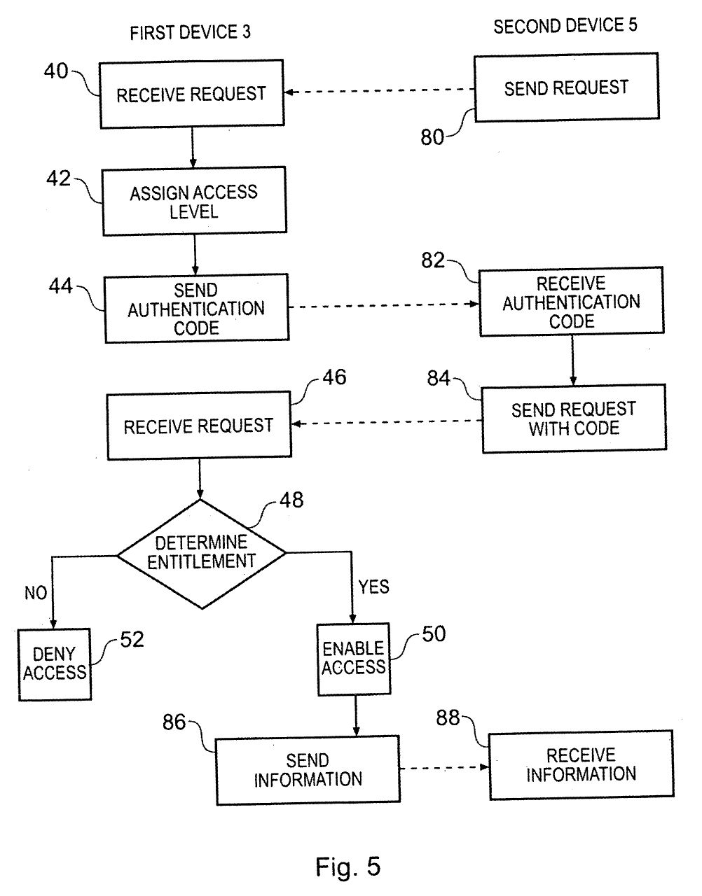

FIG. 5 illustrates the steps of the method of enabling a second device 5 access to the private information of the first device 3 including the steps which occur at the second device 5. This method is initiated at step 80 by the second device 5 sending a request for a type of private information 66. The request may be sent as part of a message. Steps 40, 42 and 44 occur as described above with reference to FIG. 4. At step 82 the second device 5 receives the requested information together with the allocated authentication code and stores it for future possible use. At step 84 the second device 5 sends another request for private information. The request message comprises an identification of the requested type of private information 66 and the allocated authentication code. The authentication code may be entered by the user of the second device 5 as part of the request message or it may be automatically attached to the request when it is sent from the second device 5. Steps 46 to 52 occur as in FIG. 4. At step 86 the requested information is sent to the second device 5 and step 88 the requested information is received by the second device 5.

Although embodiments of the present invention have been described in the preceding paragraphs with reference to various examples, it should be appreciated that modifications to the examples given can be made without departing from the spirit or scope of the invention. For example the term ‘private information’ need not be limited to the examples given above.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I claim:

1. A method for enabling access to location information at a first radio telecommunications device comprising:
assigning an access level to a first entity;
receiving a request for private information from the first entity;
determining, using the assigned access level, whether the first entity is entitled to access the requested private information; and
if there is entitlement, enabling the first entity to access the private information.

2. A method as claimed in claim 1, wherein the private information is information identifying the location of the first radio telecommunications device.

3. A method as claimed in claim 1, wherein the assigned access level defines at least one condition the satisfaction of which determines whether the first entity is or is not entitled to access the private information.

4. A method as claimed in claim 3, wherein the at least one condition defines a time of day for which there is no entitlement to access private information.

5. A method as claimed in claim 3, wherein the at least one condition defines a location or locations of the first device for which there is no entitlement to access private information.

6. A method as claimed in claim 3, wherein the at least one condition defines a mode of the first device for which there is no entitlement to access private information.

7. A method as claimed in claim 1, further comprising enabling a user of the first device to assign the access level to the first entity.

8. A method as claimed in claim 7 wherein the user of the first device assigns an access level to the first entity in response to a request for private information by the first entity.

9. A method as claimed in claim 1, wherein after the access level has been assigned to the first entity, the first device sends an authentication code to the first entity.

10. A method as claimed in claim 9, wherein the authentication code sent to the first entity is dependent upon the access level assigned to the first entity.

11. A method as claimed in claim 8, wherein the request for private information sent by the first entity comprises the authentication code and the first device uses the authentication code received with the request to determine whether the first entity is entitled to access the requested private information.

12. A method as claimed in claim 9, wherein the same authentication code is allocated to more than one entity.

13. A method as claimed in claim 1, wherein when the first device receives a request for private information from the first entity, the first device automatically determines, without user intervention, whether the first entity is entitled to access the requested private information.

14. A radio telecommunications device comprising;
a transmitter for transmitting private information;
a receiver for receiving requests for private information;
a memory for storing an indication of an access level assigned to a first entity;
a processor for determining, after a request for private information has been received from a first entity, using the stored indication, whether the first entity is entitled to the requested private information and, if there is entitlement, enabling the first entity access to the private information.

15. A method as claimed in claim 14, wherein the private information is information identifying the location of the radio telecommunications device.

16. A method as claimed in claim 14, wherein the assigned access level defines at least one condition the satisfaction of which determines whether the first entity is or is not entitled to access the private information.

17. A radio telecommunications device as claimed in claim 14 comprising a user interface for enabling the user to change the access level assigned to the first entity.

18. A radio telecommunications device as claimed in claim 14, wherein the processor automatically determines whether the first entity is entitled to access the requested private information.

19. A radio telecommunications device as claimed in claim 14, wherein the processor is arranged to allocate an authentication code to the first entity depending on the access level that the first entity has been assigned and the transmitter is arranged to transmit an authentication code to the first entity.

20. A radio telecommunications device as claimed in claim 14, wherein a request for private information comprises an authentication code and the processor is arranged to determine if the authentication code used in the request from the first entity entitles the first entity to access the private information.

21. A radio telecommunications device as claimed in claim 14, wherein the first device also comprises a transmitter for transmitting requests for private information to another device and a receiver for receiving private information from the another device.

22. A radio telecommunications device comprising;
a user interface for enabling a user of the device to assign different access rights to private information to different entities, wherein the device responds to requests for private information from an entity in dependence upon the access right previously assigned to the entity.

23. A computer program comprising program instructions for enabling access to private information and comprising;
means for enabling a user of a first device to assign to a first entity an access level, and
means for determining, after a request for private information has been received from the first entity, using the assigned access level, whether the first entity is entitled to the requested private information and, if there is entitlement, enabling the first entity access to the private information.

24. A physical entity embodying the computer program as claimed in claim 23.

25. An electromagnetic carrier signal carrying the computer program as claimed in claim 23.

26. A method for enabling access to a plurality of different types of private information at a first radio telecommunications device comprising;
enabling a user of the first device to assign an access level to a first entity wherein the access level defines which of the plurality of different types of private information the first entity is entitled to access;
receiving a request for a first type of private information from the first entity;
determining, using the assigned access level, whether the first entity is entitled to access the requested first type of private information; and
if there is entitlement, enabling the first entity to access the requested first type of private information.

27. A method as claimed in claim 26, wherein the access level for private information assigned to the first entity is one of a plurality of defined access levels wherein each level defines a different combination of types of private information.

28. A method as claimed in claim 26, wherein the type of private information includes contemporaneous variables relating to the current environment of the first device.

29. A method as claimed in claim 26, wherein the type of private information includes one or more of: private information, temperature information, user input information.

30. A method as claimed in claim 26, wherein the access level entitles the first entity to access a type of private information only at certain times.

31. A method as claimed in claim 26, wherein the access level entitles the first entity to access a type of private information only when the first device is in a particular mode.

32. A radio telecommunications device comprising;
a transmitter for transmitting a plurality of different types of private information,
a receiver for receiving requests for a plurality of different types of private information,
a user interface for enabling a user of the device to assign to a first entity an access level wherein the access level defines which of the plurality of different types of private information the first entity is entitled to access,
a processor for determining, after a request for a first type of private information has been received from a first entity, whether the first entity is entitled to the requested first type of private information and, if there is entitlement, enabling the first entity access to the first type of private information.

33. A radio telecommunications device as claimed in claim 32, wherein the user interface enables the user to assign an access level for private information, from a plurality of defined access levels for private information, to the first entity wherein each access level defines a different type of private information.

34. A radio telecommunications device as claimed in claim 32, comprising means for enabling the user to control what combinations of types of private information are accessible with an access level.

35. A method for transmitting private information from a first radio telecommunications device to a second radio telecommunications device comprising;
receiving, at the second device, an authentication code from the first device; and sending a request for private information to the first device, comprising the authentication code.

36. A method as claimed in claim 35, wherein the private information is private information.

37. A method as claimed in claim 35, wherein there are a plurality of different types of private information, the authentication code is dependent upon the type of private information to which the second device is entitled, and the request for private information to the first device comprises an identification of the type of private information and the authentication code.

38. A radio telecommunications device comprising:
a transmitter for transmitting requests for private information where the request comprises an authentication code,
a receiver for receiving private information, and
a processor for managing authentication codes so that the request for private information to another device is sent with an authentication code allocated by the another device.
